(19) United States
(12) Patent Application Publication
(10) Pub. No.: US 2021/0074163 A1
(43) Pub. Date: Mar. 11, 2021

(54) PROVISIONING FOR JUST IN TIME AUTONOMOUS VEHICLE DEPLOYMENT

(71) Applicant: International Business Machines Corporation, Armonk, NY (US)

(72) Inventors: Kyle D. Robeson, North York (CA); Steve McDuff, Unionville (CA); Anthony Di Loreto, Markham (CA); Ben Z. Akselrod, Givat Shmuel (IL)

(21) Appl. No.: 16/565,978

(22) Filed: Sep. 10, 2019

(51) Int. Cl. G08G 1/00; G05D 1/02; G05D 1/00; G06Q 10/02; G06Q 10/04

(52) U.S. Cl. CPC G08G 1/202; G05D 1/0291; G06Q 10/047; G06Q 10/02; G05D 1/0027

(57) ABSTRACT

Approaches presented herein enable provisioning for just in time autonomous vehicle deployment. More specifically, a demand is predicted for a set of autonomous vehicles using a criteria. A report is obtained for at least one autonomous vehicle of a plurality of autonomous vehicles indicating a readiness status of the autonomous vehicle. The readiness status of the autonomous vehicle is analyzed, in response to the demand for a set of autonomous vehicles, to determine a preparation time for the autonomous vehicle. A time to begin preparing the autonomous vehicle in order to meet the demand is determined based on the analysis. This time comprises at least a time required to perform an activity that places the autonomous vehicle in a ready-to-use state. In response to the determination, the autonomous vehicle is instructed to start preparing at the determined time.

### TECHNICAL FIELD

The present invention relates generally to automated provisioning of an autonomous vehicle and, more specifically, to scheduling activities in a fleet of autonomous vehicles to ensure just in time deployment.

### BACKGROUND

In the near future it is predicted that autonomous vehicles, such as self-driving cars, will make up the majority of vehicles on the road. Such autonomous vehicles can be equipped with sensors and a computer system that allow the vehicle to sense its surroundings and operate with little to no human intervention. Currently, ride-sharing services are exploring the possibility of providing riders with autonomous vehicles and eventually offering autonomous vehicles as an on-demand service. Such ride-sharing services envision situations in which riders need not own a car, and rather merely need to subscribe to a service allowing them to order a self-driving car to come pick them up and take them to their destination on an as-needed basis.

### SUMMARY

Approaches presented herein enable provisioning for just in time autonomous vehicle deployment. More specifically, a demand is predicted for a set of autonomous vehicles using a criteria. A report is obtained for at least one autonomous vehicle of a plurality of autonomous vehicles indicating a readiness status of the autonomous vehicle. The readiness status of the autonomous vehicle is analyzed, in response to the demand for a set of autonomous vehicles, to determine a preparation time for the autonomous vehicle. A time to begin preparing the autonomous vehicle in order to meet the demand is determined based on the analysis. This time comprises at least a time required to perform an activity that places the autonomous vehicle in a ready-to-use state. In response to the determination, the autonomous vehicle is instructed to start preparing at the determined time.

One aspect of the present invention includes a computer-implemented method for provisioning for just in time autonomous vehicle deployment, comprising: predicting, by a computer, a demand for a set of autonomous vehicles using a criteria; obtaining, by the computer, a report for at least one autonomous vehicle of a plurality of autonomous vehicles indicating a readiness status of the at least one autonomous vehicle; analyzing, by the computer, in response to the demand for a set of autonomous vehicles, the readiness status of the at least one autonomous vehicle of the plurality to determine a preparation time for the at least one autonomous vehicle of the plurality; determining, by the computer, based on the analysis, a time to begin preparing the at least one autonomous vehicle in order to meet the demand, the time comprising at least a time required to perform an activity that places the at least one autonomous vehicle in a ready-to-use state; and instructing, by the computer, in response to the determination, the at least one autonomous vehicle of the plurality to start preparing at the determined time.

Another aspect of the present invention includes a computer system for provisioning for just in time autonomous vehicle deployment, the computer system comprising: a memory medium comprising program instructions; a bus coupled to the memory medium; and a processor, for executing the program instructions, coupled to a just in time autonomous vehicle deployment provisioning engine via the bus that when executing the program instructions causes the system to: predict a demand for a set of autonomous vehicles using a criteria; obtain a report for at least one autonomous vehicle of a plurality of autonomous vehicles indicating a readiness status of the at least one autonomous vehicle; analyze, in response to the demand for a set of autonomous vehicles, the readiness status of the at least one autonomous vehicle of the plurality to determine a preparation time for the at least one autonomous vehicle of the plurality; determine, based on the analysis, a time to begin preparing the at least one autonomous vehicle in order to meet the demand, the time comprising at least a time required to perform an activity that places the at least one autonomous vehicle in a ready-to-use state; and instruct, in response to the determination, the at least one autonomous vehicle of the plurality to start preparing at the determined time.

Yet another aspect of the present invention includes a computer program product for provisioning for just in time autonomous vehicle deployment, the computer program product comprising a computer readable hardware storage device, and program instructions stored on the computer readable hardware storage device, to: predict a demand for a set of autonomous vehicles using a criteria; obtain a report for at least one autonomous vehicle of a plurality of autonomous vehicles indicating a readiness status of the at least one autonomous vehicle; analyze, in response to the demand for a set of autonomous vehicles, the readiness status of the at least one autonomous vehicle of the plurality to determine a preparation time for the at least one autonomous vehicle of the plurality; determine, based on the analysis, a time to begin preparing the at least one autonomous vehicle in order to meet the demand, the time comprising at least a time required to perform an activity that places the at least one autonomous vehicle in a ready-to-use state; and instruct, in response to the determination, the at least one autonomous vehicle of the plurality to start preparing at the determined time.

Still yet, any of the components of the present invention could be deployed, managed, serviced, etc., by a service provider who offers to implement passive monitoring in a computer system.

Embodiments of the present invention also provide related systems, methods, and/or program products.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture in which the invention may be implemented according to illustrative embodiments.

FIG. 2 shows a system diagram describing the functionality discussed herein according to illustrative embodiments.

FIG. 3 shows an implementation of provisioning for just in time autonomous vehicle deployment according to illustrative embodiments.

FIG. 4 shows an autonomous vehicle fleet preparation schedule according to illustrative embodiments.

FIG. 5 shows a process flowchart for provisioning for just in time autonomous vehicle deployment according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide for provisioning for just in time autonomous vehicle deployment. More specifically, a demand is predicted for a set of autonomous vehicles using a criteria. A report is obtained for at least one autonomous vehicle of a plurality of autonomous vehicles indicating a readiness status of the autonomous vehicle. The readiness status of the autonomous vehicle is analyzed, in response to the demand for a set of autonomous vehicles, to determine a preparation time for the autonomous vehicle. A time to begin preparing the autonomous vehicle in order to meet the demand is determined based on the analysis. This time comprises at least a time required to perform an activity that places the autonomous vehicle in a ready-to-use state. In response to the determination, the autonomous vehicle is instructed to start preparing at the determined time.

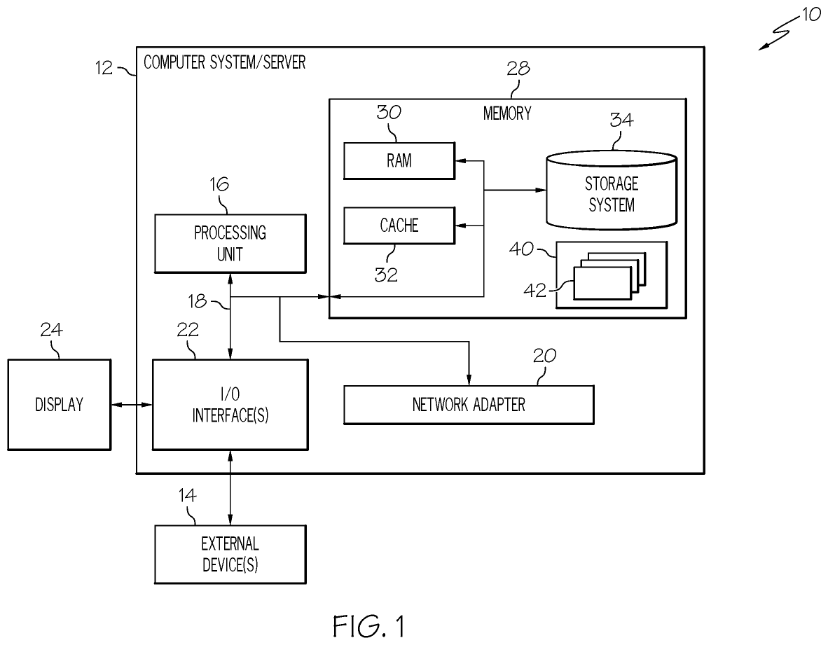

Referring now to FIG. 1, a computerized implementation 10 of an embodiment for provisioning for just in time autonomous vehicle deployment will be shown and described. Computerized implementation 10 is only one example of a suitable implementation and is not intended to suggest any limitation as to the scope of use or functionality of embodiments of the invention described herein. Regardless, computerized implementation 10 is capable of being implemented and/or performing any of the functionality set forth hereinabove.

In computerized implementation 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

This is intended to demonstrate, among other things, that the present invention could be implemented within a network environment (e.g., the Internet, a wide area network (WAN), a local area network (LAN), a virtual private network (VPN), etc.), a cloud computing environment, a cellular network, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer system/server 12 is intended to demonstrate that some or all of the components of implementation 10 could be deployed, managed, serviced, etc., by a service provider who offers to implement, deploy, and/or perform the functions of the present invention for others.

Computer system/server 12 is intended to represent any type of computer system that may be implemented in deploying/realizing the teachings recited herein. Computer system/server 12 may be described in the general context of computer system/server executable instructions, such as program modules, being executed by a computer system. Generally, program modules may include routines, programs, objects, components, logic, data structures, and so on, that perform particular tasks or implement particular abstract data types. In this particular example, computer system/server 12 represents an illustrative system for provisioning for just in time autonomous vehicle deployment. It should be understood that any other computers implemented under the present invention may have different components/software, but can perform similar functions.

The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for provisioning for just in time autonomous vehicle deployment, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and/or an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The inventors of the present invention have found that as autonomous vehicles, such as self-driving cars, make up an increasing share of the vehicles on our roads, there will be an increasing demand for “cars as a service,” where individuals order a self-driving car to come get them and take them to their destination. However, in order to offer such a service, a service provider will need techniques to manage a fleet of autonomous vehicle. Without efficient management, resources, such as time and energy, may be wasted preparing vehicles that will not be used or failing to adequately prepare vehicles that will then be deemed inappropriate by passengers.

Accordingly, the inventors of the present invention have developed techniques for autonomous vehicle fleet management that permits an appropriate level of autonomous vehicles to be prepared in a timely fashion based on anticipated user demand. Preparatory activities, such as heating (or cooling) a vehicle, charging/fueling the vehicle, cleaning the vehicle, and performing any required maintenance on the vehicle can be scheduled and timed such that an appropriate autonomous vehicle will be prepared and ready (both with respect to comfort and safety) just when it will be requested by a user.

Furthermore, embodiments of the present invention offer several advantages for autonomous vehicle fleet management. For example, embodiments of the present invention can be used to reduce, if not prevent, resource wastage. Timely preparation, as enabled by embodiments, results in no wasted energy resources heating or cooling a vehicle that will not be needed. Furthermore, an electrical charge or other fuel is not added to a vehicle that will not be used. As to autonomous vehicles that will be requested by users, these vehicles are prepared essentially “just in time,” preventing wait times and other delays from the perspective of a user.

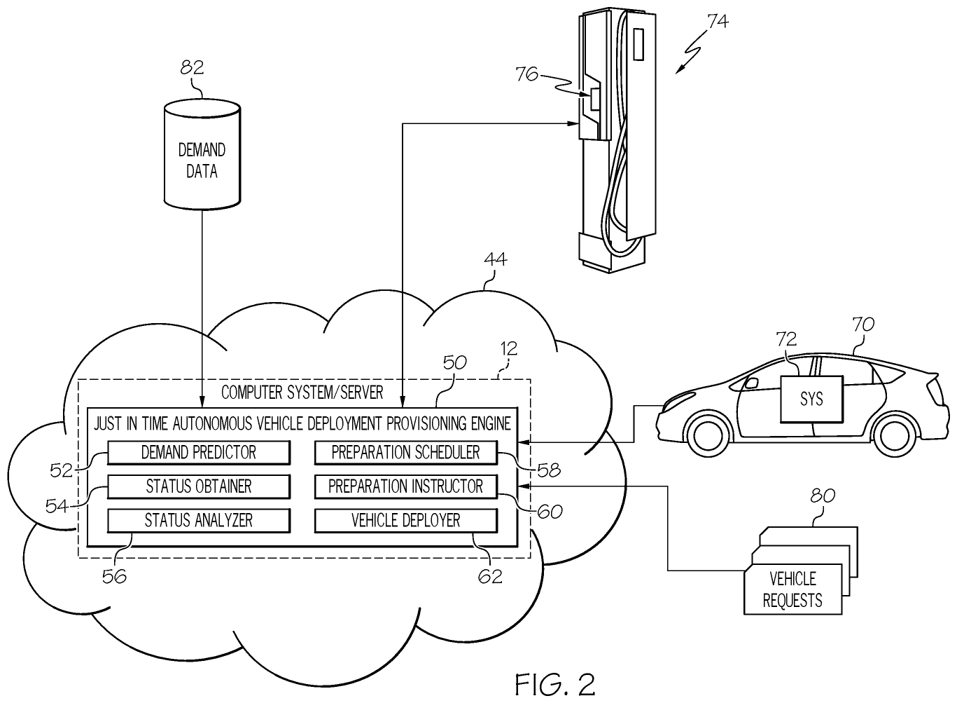

Referring now to FIG. 2, a system diagram describing the functionality discussed herein according to an embodiment of the present invention is shown. It is understood that the teachings recited herein may be practiced within any type of computing environment, including, but not limited to, a networked computing environment 44 (e.g., a cloud computing environment). A stand-alone computer system/server 12 is shown in FIG. 2 for illustrative purposes only. In the event the teachings recited herein are practiced in a networked computing environment, each client need not have a just in time autonomous vehicle deployment provisioning engine 50 (hereinafter “system 50”). Rather, all or part of system 50 could be loaded on a server or server-capable device that communicates (e.g., wirelessly) with clients to provide for provisioning for just in time autonomous vehicle deployment. Regardless, as depicted, system 50 is shown within computer system/server 12. In general, system 50 can be implemented as program/utility 40 on computer system 12 of FIG. 1 and can enable the functions recited herein.

Along these lines, system 50 may perform multiple functions. Specifically, among other functions, system 50 can provision for just in time autonomous vehicle deployment in a networked computing environment. To accomplish this, system 50 can include a set of components (e.g., program modules 42 of FIG. 1) for carrying out embodiments of the present invention. These components can include, but are not limited to, demand predictor 52, status obtainer 54, status analyzer 56, preparation scheduler 58, preparation instructor 60, and vehicle deployer 62.

Through computer system/server 12 and/or networked computing environment 44, system 50 can be in communication with one or more computer systems 72 (e.g., client computing devices), each associated with an autonomous vehicle 70. Autonomous vehicle 70 can be any sort of vehicle used to move people or any other load from one location to another, operated, at least in part, by computer system 72. Although embodiments of the present invention will be described primarily with respect to autonomous cars, other forms of autonomous vehicles are within the scope of the invention. For example, in some embodiments, autonomous vehicle 70 can be an autonomous pod, trolley, rail-bound vehicle, ferry, bus, air transport vehicle, etc. According to embodiments of the present invention, computer system 72 of autonomous vehicle 70 can be capable of operating (e.g., driving, navigating, steering) autonomous vehicle 70 without the need for human intervention, although, in some embodiments, computer system 72 of autonomous vehicle 70 may be capable of handling at least some control of autonomous vehicle 70 to a human operator, if instructed to do so. Computer system 72 can be configured to operate any program, software, or infrastructure for controlling autonomous vehicle 70 now known or later developed. In addition, computer system 72 can control other auxiliary features of autonomous vehicle 70, such as a heat and/or air conditioning system, window controls, internal and external lights, etc. In some embodiments, computer system 72 can serve as a client system receiving instructions from system 50 to execute functions of embodiments of the present invention.

In some embodiments, through computer system/server 12 and/or networked computing environment 44, system 50 can be in communication with one or more computer systems 76 (e.g., client computing devices), each associated with a maintenance device 74. Maintenance devices 74 can include any automated device used to place an autonomous vehicle 70 in condition for use. Examples of maintenance devices 74 include, but are not limited to, vehicle charging stations, car washes, and robotic vacuum cleaners. According to embodiments of the present invention, computer system 76 of maintenance device 74 can be capable of automatically performing a maintenance operation on an autonomous vehicle 70 without the need for human intervention, although, in some embodiments, computer system 76 of maintenance device 74 may be capable of handling at least some control of maintenance device 74 to a human operator, if instructed to do so. Computer system 76 can be configured to operate any program, software, or infrastructure now known or later developed for controlling actuators in maintenance device 74 that perform an operation. In addition, computer system 76 can serve as a client system receiving instructions from system 50 to execute functions of embodiments of the present invention. In some embodiments, maintenance device 74 may be components of an automated garage.

According to some embodiments of the present invention, system 50 can receive/obtain requests 80 for autonomous vehicles 70. Requests 80 can be initiated by actual users when the user wants an on-demand autonomous vehicle. Requests 80 can include a time (e.g., in an hour, as soon as possible, etc.) and place (e.g., current location of user, designated location) that the user would like the autonomous vehicle, and, in some embodiments, specifications for the type of vehicle desired, such as class of vehicle (e.g., sedan, truck, van), capacity of vehicle (e.g., minimum number of occupant places needed), and function of vehicle (e.g., carpool, cargo haul), etc.

System 50 has access to data store 82 of historic demand data for autonomous vehicles 70. This data can include records of previous requests 80 for autonomous vehicles 70. In some embodiments, the data in data store 82 can be structured or searchable. In some embodiments, the data in data store 82 has been analyzed for trends. For example, data store 82 can contain trends indicating when demand waxes or wanes. This trend data can be further categorized by particulars, such as trends in locations and specifications of vehicles requested. For example, demand data in data store 82 may reflect that more large sedans are requested during the lunch hour in a downtown area, whereas more family-sized minivans are requested in suburban areas in the evenings.

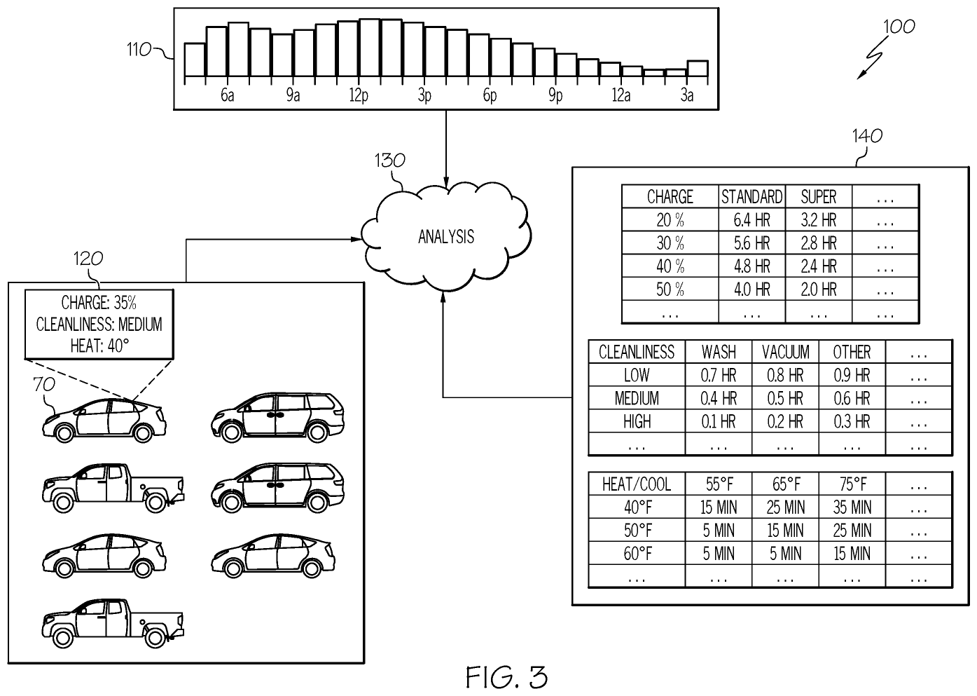

Referring now to FIG. 3 in connection with FIG. 2, an implementation 100 of provisioning for just in time autonomous vehicle deployment is shown, according to illustrative embodiments. Demand predictor 52, as performed by computer system/server 12, can predict a demand 110 for a set of autonomous vehicles 70 using a criteria. According to some embodiments, demand predictor 52 can use one or more models based on historic demand data 82 to anticipate time periods at which vehicles will be required and in what quantities. Such models can be configured to learn usage patterns of autonomous vehicles 70 over a period of time, and to update such learning periodically as new data becomes available. Demand predictor 52 can obtain predicted demand data 82 for any time or period of time during any day. Demand predictor 52 can distinguish between demands particular to specific times of day (e.g., mornings versus evenings), days of the week (e.g., weekdays versus weekend days), as well as special occasions (e.g., holidays, other public events such as a festival). The models used by demand predictor 52 can include any demand prediction model presently known or later discovered.

In addition to predicting demand within a time period, demand predictor 52 can also predict demand within a geographic area. For example, demand predictor 52 can distinguish a number of vehicles required within a city during rush hour versus a number of vehicles required in a neighboring suburban area. As will be discussed in more detail below, demand locations can be used to ensure that an adequate number of autonomous vehicles are prepared to be deployed in each geographic area.

According to embodiments of the present invention, demand predictor 52 can feed criteria information into a demand model to customize the demand model to the particular needs of a manager of a particular autonomous vehicle fleet or other service provider of autonomous vehicles as a service. This criteria information can include, but is not limited to: a number of subscribers, previous usage history of the subscribers, a number of autonomous vehicles required during rush hours, an average number of autonomous vehicles required during non-rush hours, and a number of autonomous vehicles required to satisfy a margin of error for an estimated number of autonomous vehicles.

The number of subscribers can include an overall number of subscribers, as well as numbers within different categories of subscribers, which can be assigned different weights within a demand model. For example, a service may have “X” number of subscribers, but only N % of “X” make frequent use of the service, and only M % have a regular pattern (e.g., daily, weekly) to their usage. As such, usage patterns of the M % of subscribers may be assigned a greater weight than the remainder of the X subscribers. Furthermore, demand models can be configured to include previous usage histories of the subscribers. Such historic usage, and therefore previous demand, can be used to predict future usage patterns.

Historic peak-hour and off-hour data can also be fed into a demand model. Such data can include maximum and minimum autonomous vehicle usage for a given period of time. Such data can also include a range of data over a period of time. In some cases, peak-hour and off-hour data can include usage figures for all vehicles used during a time period, not merely autonomous vehicles. As more users are likely to subscribe to a vehicle-as-a-service system over time, generalized figures for all vehicles on the road can allow demand predictor 52 to recognize an upper limit of vehicles on the road when calculating the share of total vehicles that will be autonomous vehicles.

In some embodiments of the present invention, a demand model used by demand predictor 52 can be configured to include a margin of error in estimating a number of vehicles required. In some embodiments, this margin of error can be a percentage of the total number of actual needed autonomous vehicles (e.g., 10% more vehicles ready) or a set number of additional vehicles (e.g., five more vehicles ready than needed). In some embodiments, the margin of error can be dependent on a time of day or relative demand (e.g., 10% more vehicles available during peak hours or when demand is high versus five percent more vehicles available during off hours or when demand is low). In some embodiments, the margin of error can be adjusted to account for volatility if actual demand is significantly higher or lower than expected (e.g., when actual demand is lower than expected, increase the margin of error).

Still referring to FIG. 3 in connection with FIG. 2, status obtainer 54, as performed by computer system/server 12, can obtain a report 120 for at least one autonomous vehicle 70 of a plurality of autonomous vehicles indicating a readiness status of the at least one autonomous vehicle. Obtaining this status information permits system 50 to ensure that autonomous vehicle 70 is ready to drive safely and comfortably for a user and, as discussed below, is prepared on time. As discussed above, system 50 can be connected by network 44 or other information sharing structure, to computer systems 72, each for an autonomous vehicle 70. Network 44 can include any number of autonomous vehicle computer systems 72. In some embodiments, autonomous vehicle computer system 72 can be configured to collect and organize readiness status information from sensors and other status indicators within autonomous vehicle 70. In these embodiments, autonomous vehicle computer system 72 can generate report 120 for transmission to system 50 over network 44. In some other embodiments, a set of computerized sensors in autonomous vehicle 70 can report status information directly to system 50 over network 44. According to some embodiments, status obtainer 54 can obtain report 120 through network 44 substantially continuously, periodically, or in response to a status inquiry sent by system 50 over network 44 to autonomous vehicle computer systems 72. Autonomous vehicle computer system 72 can be configured to send status reports 120 when autonomous vehicle 70 is in a garage or otherwise awaiting assignment. Autonomous vehicle computer system 72 can be associated with a vehicle identifier included in report 120 to permit status obtainer 54 to differentiate status information from different autonomous vehicles 70.

Each autonomous vehicle 70 can include a set of sensors or other detectors capable of taking a reading connected to computer system 72. Such sensors can include an electric meter for registering a charge of autonomous vehicle 70. Another sensor can be a fuel meter for registering a quantity of fuel (such as gasoline) in autonomous vehicle 70. Yet another sensor can be a heat sensor, such as a thermometer, for measuring a level of heat in autonomous vehicle 70. Still another sensor can be a camera configured with object recognition capabilities to assess a cleanliness of autonomous vehicle 70. Another sensor for assessing a cleanliness of autonomous vehicle 70 can be a light sensor on the body of autonomous vehicle 70. A measure of maintenance can also be obtained from a camera configured with object recognition capabilities and/or a set of sensors in an engine comportment of autonomous vehicle 70, such as those that trigger a “check-engine-light” in some cars. Additionally, a clock or mile counter can be used to determine if autonomous vehicle 70 is due for a routine maintenance. Similarly, a level of safety and a measure of comfort can be sensed through cameras and sensors attached to relevant components of autonomous vehicle 70.

In some embodiments, a level of cleanliness, maintenance, safety, and/or comfort can be obtained from a previous passenger/user of autonomous vehicle 70. When departing autonomous vehicle 70, a passenger/user can indicate (e.g., in computer system 72 of autonomous vehicle 70, through a vehicle-as-a-service computer application) the cleanliness, maintenance, safety, and/or comfort status of autonomous vehicle 70 at the user's time of departure from autonomous vehicle 70 (e.g., vehicle needs to be cleaner, vehicle not comfortable enough). Such user-indicated status can, in some embodiments, be used in conjunction with other sensors.

It should also be understood that in some embodiments, status sensors need not be included in each autonomous vehicle 70 nor connected to computer system 72. In some embodiments, sensors can reside within a garage or other area autonomous vehicles 70 are stored. Such sensors can report directly to system 50. A camera that views a group of autonomous vehicles 70 for damage is an example of such a generalized sensor.

Still referring to FIG. 3 in connection with FIG. 2, status analyzer 56, as performed by computer system/server 12, can analyze, in response to the demand for a set of autonomous vehicles 72, the readiness status 120 of the at least one autonomous vehicle 72 of the plurality to determine a preparation time for the at least one autonomous vehicle 72 of the plurality. In some embodiments, this preparation time analysis 130 can be performed by system 50. In some other embodiments, preparation time analysis 130 it can be performed for each autonomous vehicle 70 by a status analyzer 56 residing on that vehicle's client computer system 72, with a final result of analysis 130 being transmitted to system 50 for the particular autonomous vehicle 70. In any case, status analyzer 56 can review readiness status reports 120 from autonomous vehicle 72 and determine, from a current status in report 120, an amount of time required to place autonomous vehicle 72 in a safe and comfortable state, ready to pick up a user.

To accomplish this, according to some embodiments, status analyzer 56 can determine a time needed to bring each status conveyed in status report 120 to a ready status for autonomous vehicle 70. Statuses reported in status report 120 can be relative to a full, complete, ready, etc., status, and can include relative indicators (e.g., low, medium, and high), percentages (e.g., N % full), fractions (N out of NN), etc.

In some embodiments, status analyzer 56 can use reference information stored in a data store as a source to determine estimated preparation times based on a current status of vehicle 70. This reference information can be stored in a structured format, such as reference tables 140 or any unstructured format. Preparation time reference information can be specific to a particular vehicle 70, to a particular class or type of vehicle (e.g., make, model, and/or year), or averaged over a fleet of vehicles. In some embodiments, system 50 can learn preparation times for each autonomous vehicle 70 and/or a group of vehicles of the same class/type, over a period of time. For example, if system 500 observes a particular vehicle taking X hours to charge to full from an initial charge status of N %, system 50 can store and later retrieve such the next time the particular vehicle is at or about N % charged and thereby estimate that it will take X hours for the vehicle to reach a full charge.

In any case, status analyzer 56 can determine one or more activities required to place autonomous vehicle 70 in a ready state and a time required to accomplish each activity. In some embodiments, status analyzer 56 can determine if any of the activities can be performed essentially concurrently in order to reduce preparation time. In the case that some activities can be performed concurrently, status analyzer 56 can overlay the preparation time of these activities when determining a total preparation time to bring vehicle 70 to a ready state. For example, status analyzer 56 may determine that a particular vehicle needs to be both charged and vacuumed. Status analyzer 56 may then, when stringing together the times for all activities that will be required to make the vehicle ready, schedule vacuuming of the vehicle during the time that the vehicle will be charging, to result in a shortened total preparation time.

Furthermore, in the case that some activities can be performed while autonomous vehicle 70 is en route, status analyzer 56 can exclude the preparation time for that activity when determining a total preparation time (in garage) to bring vehicle 70 to a ready state. Alternately or additionally, status analyzer 56 can hold the en route activity as optionally included in total in-garage preparation time or travel time, depending on whether estimated travel time (dependent on estimated location of a user) is at least as long as the time to perform the potential en route activity. If not, a portion of the potential en route activity can be performed in garage, and that portion of time factored in to the total in-garage preparation time. Alternatively, system 50 may only deploy the vehicle to a user at a travel time equal or greater than the time to complete the en route activity. For example, status analyzer 56 may determine that heating an autonomous vehicle can be performed while the vehicle is en route to a user, that the vehicle will take 10 minutes to heat to a comfortable temperature. As will be discussed further below, system 50 therefore plans to deploy the vehicle to satisfy an anticipated demand for an autonomous vehicle at least 10 minutes away. Alternatively, if the anticipated demand for the autonomous is by a user that is 5 minutes away, system 50 can start the autonomous vehicle 10 minutes before the demand time, and allow the vehicle to heat for 5 minutes in garage, and then finish heating while en route to the user. In yet another alternative situation, if the anticipated demand for the autonomous is by a user more than 10 minutes away, system 50 can instruct system 72 of the autonomous vehicle to begin driving to the user at an appropriate time, but to only begin heating when the vehicle is 10 minutes from the user, thereby saving heating resources.

Other preparation activities, such as warming up an engine, would most likely be scheduled to be completed while autonomous vehicle 70 is still at a garage or base location for safety reasons.

Such preparation activities to place autonomous vehicle 70 in a ready state can include, but are not limited to: heating autonomous vehicle 70 (e.g., to a temperature comfortable to humans between 65 and 75° F.), defrosting windows or cameras of autonomous vehicle 70 (e.g., to a point a light sensor indicates a preset visibility through the window has been reached), cooling autonomous vehicle 70 (e.g., to a temperature comfortable to humans between 65 and 75° F.), charging a battery of autonomous vehicle 70 (e.g., to full capacity), filing a fuel tank of autonomous vehicle 70 (e.g., to full capacity), cleaning autonomous vehicle 70 (e.g., vacuuming an internal compartment, washing an exterior), and warming an engine of autonomous vehicle 70.

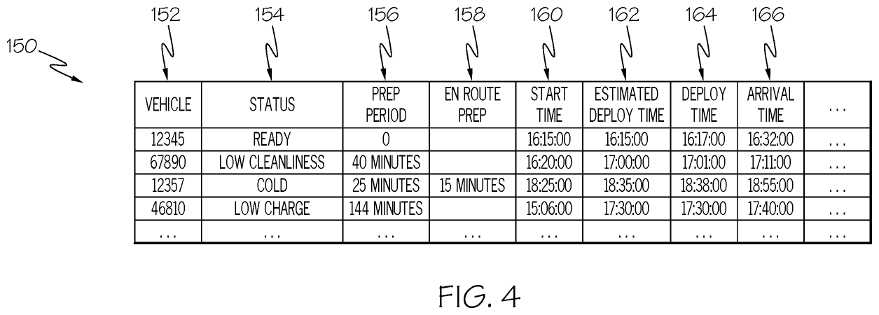

Now referring to FIG. 4 in connection with FIG. 2, preparation scheduler 58, as performed by computer system/server 12, can determine, based on the analysis, a time to begin preparing the at least one autonomous vehicle 70 in order to meet the demand, the time comprising at least a time required to perform an activity that places the at least one autonomous vehicle 70 in a ready-to-use state. Based on the demand anticipated by demand predictor 52, preparation scheduler 58 has an estimate of how many vehicles (plus a margin, if applicable) will likely be requested for a particular time. In some embodiments, this anticipated demand information can also include locations at which the vehicles will be requested. In any case, preparation scheduler 58 can create a schedule instructing a number of vehicles equivalent to the anticipated demand to each begin preparing at a time prior to the anticipated demand time equal to that vehicle's estimated preparation time. For example, if demand predictor 52 predicted at one vehicle (with no error margin) would be required at 7 pm, preparation scheduler 58 can schedule a vehicle that requires one hour of preparation time to begin preparing at 6 pm.

Preparation scheduler 58 can use any of several techniques now known or later developed to select which autonomous vehicles 70 of a fleet of autonomous vehicles. For example, in some embodiments, preparation scheduler 58 can prioritize first selecting vehicle with the shortest estimated preparation times. Alternatively, preparation scheduler 58 can prioritize first selecting vehicle with the longest estimated preparation times in order to ensure that these vehicles receive maintenance and/or to permit vehicles having shorter preparation times to remain in reserve in case swift preparation is needed in light of higher than anticipated demand. In another example, preparation scheduler 58 can prioritize selecting vehicles with a greatest or least amount of wear and tear in order to consolidate wear to fewer vehicles or to evenly wear all vehicles across a fleet, respectively. In still another example, preparation scheduler 58 can select vehicles in a round-robin fashion. In yet another example, preparation scheduler 58 can prioritize based on a type of preparation needed, such as, at a time when fuel prices are high, prioritizing selection of autonomous vehicles with relatively full fuel tanks over those that will require more fuel to fill.

In any case, preparation scheduler 58 can create preparation schedule 150 that can instruct client computer systems 72 of autonomous vehicles 70 with an order in which and/or a time at which to initiate preparation. Schedule 150 can include, but is not limited to, an identifier 152 associated with each autonomous vehicle 70 in a fleet and a status 154 of each autonomous vehicle 70. Status 154 can include details from status report 120 obtained by status obtainer 54, such as a list of activities needed to prepare vehicle 70, but could also include a relative status identifier (low, medium, high) or percentage ready (e.g., X % out of 100%). In some embodiments, schedule 150 can include, but is not limited to, a period of time 156 status analyzer 56 estimates is required to bring autonomous vehicle 70 to a ready state. Alternatively or additionally, schedule 150 can include, but is not limited to, a start preparation time 160 and an estimated deploy time 162 based on the estimated demand time and location, the preparation time needed by autonomous vehicle 70, and the selection of vehicle 70 as a vehicle to be deployed. Furthermore, alternatively or additionally, schedule 150 can include, but is not limited to, an actual deploy time 164 of vehicle 70 in response to an actual request 80 for an autonomous vehicle 70, as well as an arrival time 166 of vehicle 70 at a location of the user requesting autonomous vehicle 70. Times and locations of actual requests 80 can be stored in data store 82 of historic demand data to improve the demand models relied on by demand predictor 52.

In some embodiments, a fleet of autonomous vehicles 70 can be dispersed throughout an area, with at least one vehicle being stored in each of several storage/garage locations. In this embodiment, preparation scheduler 58 can also include in schedule 150 a storage/garage location from which an autonomous vehicle 70 is to be deployed based on a predicted demand location. Preparation scheduler 58 may determine, for example, that an autonomous vehicle in garage closest to a predicted demand will take longer to prepare than a vehicle in a further away garage and that, even with travel time, the further away autonomous vehicle will take less time and effort to prepare and deliver to satisfy the predicted demand. As such, in this case, preparation scheduler 58 schedules the further away autonomous vehicle to begin preparing at a particular time to respond to the predicted demand.

It should be understood that preparation scheduler 58 ensures that system 50 has an appropriate level of autonomous vehicle 70 prepared and ready to meet an upcoming demand, without wasting energy, time, and/or resources preparing autonomous vehicle that will most likely not be needed. Furthermore, this allows system 50 to manage resource expenses, conserving money, time, and energy. Moreover, by preparing an adequate number of autonomous vehicles 70 for a given time and/or location, system 50 ensures that ill-prepared vehicles that would be deemed inappropriate by passengers are not deployed to users.

Still referring to FIG. 4 in connection with FIG. 2, preparation instructor 60, as performed by computer system/server 12, can instruct, in response to the determination, the at least one autonomous vehicle 70 of the plurality to start preparing at the determined time 160. To accomplish this, according to one embodiment of the present invention, preparation instructor 60 can broadcast schedule 150 to the computer systems 72 of all autonomous vehicles 70 in a fleet. In this embodiment, each computer system 72 can identify its corresponding vehicle in schedule 150, read preparation start time 160 from schedule 150, and instruct vehicle 70 to begin preparing at preparation start time 160. In some other embodiments, preparation instructor 60 only sends the portion of schedule 150 to each computer systems 72 relevant to the autonomous vehicle 70 associated with that computer system. In this embodiment, each computer system 72 can read preparation start time 160 from the transmitted information and instruct vehicle 70 to begin preparing at preparation start time 160. In still other embodiments, preparation instructor 60 can merely instruct computer system 72 of a particular autonomous vehicle 70 to begin preparing at preparation start time 160. In this embodiment, this instruction can be sent at or before preparation start time 160.

In addition to instructing computer system 72 of autonomous vehicle 70 to begin performing one or more preparation activities, preparation instructor 60 can also or alternatively instruct one or more computer systems 76, each associated with a maintenance device 74, to perform a preparation activity on autonomous vehicle 70. In some embodiments, maintenance devices 74 can be part of an automated garage, controlled by system 50 or capable of receiving instructions from system 50 through client computer systems 76. In one example, preparation instructor 60 can send an instruction to client computer systems 76 of an electrical charger type maintenance devices 74 to attach a charging cord to an autonomous vehicle 70 and to begin charging a battery of that autonomous vehicle 70. In another example, preparation instructor 60 can send an instruction to client computer systems 72 of autonomous vehicle 70 to drive into a car wash type maintenance devices 74, and can send another instruction to client computer systems 76 of the car wash type maintenance devices 74 to initiate a wash sequence. Although in some embodiments, preparation/maintenance activities are performed by an automated garage, in some other embodiments, an alert can be sent to a person to perform a particular task instead.

Vehicle deployer 62, as performed by computer system/server 12, can receive vehicle requests 80 for autonomous vehicles 70 and deploy to the issuers of these requests autonomous vehicles 70 that were made ready by the processes discussed above. Assuming demand predictor 52 adequately estimated demand for a given time and/or location and that status analyzer correctly determined a time to prepare autonomous vehicles 70, then an adequate supply of autonomous vehicles 70 should be ready and available to be deployed at the time and/or location. In the event that actual demand exceeds that estimated by demand predictor 52, remaining preparation time 156 from schedule 150 for a next available autonomous vehicle 70 can be added to an estimated time of arrival provided to a user with a pending request 80 for an autonomous vehicle 70. Subsequent pending requests 80 can likewise be adjusted with estimated times of arrival for next available autonomous vehicles 70 and preparation scheduler 58 can prioritize preparation of vehicles with the least required preparation time to meet the unanticipated demand as quickly as possible.

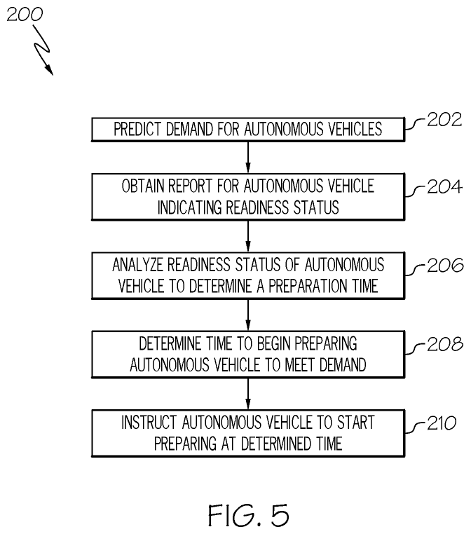

As depicted in FIG. 5, in one embodiment, a system (e.g., computer system/server 12) carries out the methodologies disclosed herein. Shown is a process flowchart 200 for provisioning for just in time autonomous vehicle deployment. At 202, a demand 110 is predicted for a set of autonomous vehicles using a criteria. At 204, a report 120 is obtained for at least one autonomous vehicle 70 of a plurality of autonomous vehicles indicating a readiness status 120 of the at least one autonomous vehicle 70. At 206, in response to the demand 110 for a set of autonomous vehicles, the readiness status 120 of the at least one autonomous vehicle 70 of the plurality is analyzed to determine a preparation time 156 for the at least one autonomous vehicle 70 of the plurality. At 208, based on the analysis, a time 160 to begin preparing the at least one autonomous vehicle 70 in order to meet the demand 110 is determined, the time comprising at least a time required to perform an activity that places the at least one autonomous vehicle 70 in a ready-to-use state. At 210, in response to the determination, the at least one autonomous vehicle 70 of the plurality is instructed to start preparing at the determined time 160.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for provisioning for just in time autonomous vehicle deployment. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for provisioning for just in time autonomous vehicle deployment. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is apparent that there has been provided herein approaches to automate autonomous vehicle fleet preparation. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A computer-implemented method for provisioning for just in time autonomous vehicle deployment, comprising:
predicting, by a computer, a demand for a set of autonomous vehicles using a criteria;
obtaining, by the computer, a report for at least one autonomous vehicle of a plurality of autonomous vehicles indicating a readiness status of the at least one autonomous vehicle;
analyzing, by the computer, in response to the demand for a set of autonomous vehicles, the readiness status of the at least one autonomous vehicle of the plurality to determine a preparation time for the at least one autonomous vehicle of the plurality;
determining, by the computer, based on the analysis, a time to begin preparing the at least one autonomous vehicle in order to meet the demand, the time comprising at least a time required to perform an activity that places the at least one autonomous vehicle in a ready-to-use state; and
instructing, by the computer, in response to the determination, the at least one autonomous vehicle of the plurality to start preparing at the determined time.

2. The method of claim 1, wherein the demand for autonomous vehicles comprises an estimated number of the autonomous vehicles and time period in which the estimated number of the autonomous vehicles is required.

3. The method of claim 1, wherein the criteria comprises at least one criteria selected from the group consisting of: a number of subscribers, previous usage history of the subscribers, a number of autonomous vehicles required during rush hours, an average number of autonomous vehicles required during non-rush hours, and a number of autonomous vehicles required to satisfy a margin of error for an estimated number of autonomous vehicles.

4. The method of claim 1, wherein the readiness status of the at least one autonomous vehicle comprises at least one item selected from the group consisting of: a charge level, a fuel level, a measure of cleanliness, a measure of maintenance, a level of safety, a level of heat, and a measure of comfort.

5. The method of claim 1, wherein the activity that places the at least one autonomous vehicle in a ready-to-use state comprises at least one activity selected from the group consisting of: heating the at least one autonomous vehicle, defrosting windows of the at least one autonomous vehicle, cooling the at least one autonomous vehicle, charging a battery of the at least one autonomous vehicle, filing a fuel tank of the at least one autonomous vehicle, cleaning the at least one autonomous vehicle, and warming an engine of the at least one autonomous vehicle.

6. The method of claim 1, the method further comprising:
determining a time to begin preparation for more than one autonomous vehicle of the plurality of autonomous vehicles;
generating a timed order to begin a plurality of activities based on the determined times and an associated time for performing each activity; and
initiating preparation of each of the more than one autonomous vehicle according to the timed order.

7. The method of claim 1, the instruction to start preparing at the determined time comprising an instruction to perform the activity that places the at least one autonomous vehicle in a ready-to-use state while en route to a user pickup location.

8. A computer system for provisioning for just in time autonomous vehicle deployment, the computer system comprising:
a memory medium comprising program instructions;
a bus coupled to the memory medium; and
a processor, for executing the program instructions, coupled to a just in time autonomous vehicle deployment provisioning engine via the bus that when executing the program instructions causes the system to:
predict a demand for a set of autonomous vehicles using a criteria;
obtain a report for at least one autonomous vehicle of a plurality of autonomous vehicles indicating a readiness status of the at least one autonomous vehicle;
analyze, in response to the demand for a set of autonomous vehicles, the readiness status of the at least one autonomous vehicle of the plurality to determine a preparation time for the at least one autonomous vehicle of the plurality;
determine, based on the analysis, a time to begin preparing the at least one autonomous vehicle in order to meet the demand, the time comprising at least a time required to perform an activity that places the at least one autonomous vehicle in a ready-to-use state; and
instruct, in response to the determination, the at least one autonomous vehicle of the plurality to start preparing at the determined time.

9. The computer system of claim 8, wherein the demand for autonomous vehicles comprises an estimated number of the autonomous vehicles and time period in which the estimated number of the autonomous vehicles is required.

10. The computer system of claim 8, wherein the criteria comprises at least one criteria selected from the group consisting of: a number of subscribers, previous usage history of the subscribers, a number of autonomous vehicles required during rush hours, an average number of autonomous vehicles required during non-rush hours, and a number of autonomous vehicles required to satisfy a margin of error for an estimated number of autonomous vehicles.

11. The computer system of claim 8, wherein the readiness status of the at least one autonomous vehicle comprises at least one item selected from the group consisting of: a charge level, a fuel level, a measure of cleanliness, a measure of maintenance, a level of safety, a level of heat, and a measure of comfort.

12. The computer system of claim 8, wherein the activity that places the at least one autonomous vehicle in a ready-to-use state comprises at least one activity selected from the group consisting of: heating the at least one autonomous vehicle, defrosting windows of the at least one autonomous vehicle, cooling the at least one autonomous vehicle, charging a battery of the at least one autonomous vehicle, filing a fuel tank of the at least one autonomous vehicle, cleaning the at least one autonomous vehicle, and warming an engine of the at least one autonomous vehicle.

13. The computer system of claim 8, the instructions further causing the system to:
determine a time to begin preparation for more than one autonomous vehicle of the plurality of autonomous vehicles;
generate a timed order to begin a plurality of activities based on the determined times and an associated time for performing each activity; and
initiate preparation of each of the more than one autonomous vehicle according to the timed order.

14. The computer system of claim 8, wherein the instruction to start preparing at the determined time comprise an instruction to perform the activity that places the at least one autonomous vehicle in a ready-to-use state while en route to a user pickup location.

15. A computer program product for provisioning for just in time autonomous vehicle deployment, the computer program product comprising a computer readable hardware storage device, and program instructions stored on the computer readable hardware storage device, to:
predict a demand for a set of autonomous vehicles using a criteria;
obtain a report for at least one autonomous vehicle of a plurality of autonomous vehicles indicating a readiness status of the at least one autonomous vehicle;
analyze, in response to the demand for a set of autonomous vehicles, the readiness status of the at least one autonomous vehicle of the plurality to determine a preparation time for the at least one autonomous vehicle of the plurality;
determine, based on the analysis, a time to begin preparing the at least one autonomous vehicle in order to meet the demand, the time comprising at least a time required to perform an activity that places the at least one autonomous vehicle in a ready-to-use state; and
instruct, in response to the determination, the at least one autonomous vehicle of the plurality to start preparing at the determined time.

16. The computer program product of claim 15, wherein the demand for autonomous vehicles comprises an estimated number of the autonomous vehicles and time period in which the estimated number of the autonomous vehicles is required.

17. The computer program product of claim 15, wherein the criteria comprises at least one criteria selected from the group consisting of: a number of subscribers, previous usage history of the subscribers, a number of autonomous vehicles required during rush hours, an average number of autonomous vehicles required during non-rush hours, and a number of autonomous vehicles required to satisfy a margin of error for an estimated number of autonomous vehicles.

18. The computer program product of claim 15, wherein the readiness status of the at least one autonomous vehicle comprises at least one item selected from the group consisting of: a charge level, a fuel level, a measure of cleanliness, a measure of maintenance, a level of safety, a level of heat, and a measure of comfort.

19. The computer program product of claim 15, wherein the activity that places the at least one autonomous vehicle in a ready-to-use state comprises at least one activity selected from the group consisting of: heating the at least one autonomous vehicle, defrosting windows of the at least one autonomous vehicle, cooling the at least one autonomous vehicle, charging a battery of the at least one autonomous vehicle, filing a fuel tank of the at least one autonomous vehicle, cleaning the at least one autonomous vehicle, and warming an engine of the at least one autonomous vehicle.

20. The computer program product of claim 15, the computer readable storage device further comprising instructions to:
determine a time to begin preparation for more than one autonomous vehicle of the plurality of autonomous vehicles;
generate a timed order to begin a plurality of activities based on the determined times and an associated time for performing each activity; and
initiate preparation of each of the more than one autonomous vehicle according to the timed order.
